(19) United States
(12) Patent Application Publication
(10) Pub. No.: US 2026/0301249 A1
(43) Pub. Date: Oct. 1, 2026

(54) ACCOUNTING INFORMATION DISPLAY METHOD, AND PROGRAM AND INFORMATION PROCESSING DEVICE USING SAID METHOD

(71) Applicant: MKK ASSET MANAGEMENT CO.,LTD., Musashino-shi, Tokyo (JP)

(72) Inventor: Megumi MATSUMOTO, Suginami-ku, Tokyo (JP)

(73) Assignee: MKK ASSET MANAGEMENT CO.,LTD., Musashino-shi, Tokyo (JP)

(21) Appl. No.: 18/879,039

(22) PCT Filed: Jul. 7, 2023
(86) PCT No.: PCT/JP2023/025237

§ 371 Date: Dec. 26, 2024

(30) Foreign Application Priority Data
Jul. 8, 2022 (JP) 2022-110640

(51) Int. Cl. G06T 11/26; G06Q 40/06

(52) U.S. Cl. CPC G06T 11/26; G06Q 40/064

(57) ABSTRACT

An accounting information display method allowing visual understanding of operating results and a financial condition of a company, and a program and an information processing apparatus using the method.

The accounting information display method for displaying information on accounting includes: displaying a graph in which a vertical axis represents a profit rate and a horizontal axis represents a sales amount; placing, in the graph, a pictorial figure relating to the sales and being in a size that corresponds to the sales amount of each client; and placing a pictorial figure in the pictorial figure relating to the sales, the pictorial figure relating to variable cost and being in a size that corresponds to an amount of the variable cost. The pictorial figure relating to the sales is placed at a position corresponding to the profit rate and the sales amount in the graph.

### TECHNICAL FIELD

The present invention relates to a method for displaying information on accounting, and a program and an information processing apparatus using the method.

### BACKGROUND ART

Financial statements (settlement of accounts) are prepared on the basis of double-entry bookkeeping in order to clarify operating results and a financial condition of a company. Of the financial statements, a balance sheet and an income statement are mainly used.

The balance sheet presents assets and liabilities of the company as of the end of a fiscal year, and presents a financial position of the company on the account settlement date. The income statement presents how much sales are made, how much expenses are incurred, and how much profit is earned within a given period of time.

However, in order to accurately understand the operating results and the financial condition of the company by reading these financial statements, even an accounting professional, such as a certified public accountant or tax accountant, or accounting personnel of the company is required to closely examine each figure in these financial statements. For this reason, systems and the like that display contents of the balance sheet in a manner to allow intuitive understanding thereof are conventionally disclosed. For example, the following configuration is disclosed in Patent Document 1. Display means for a balance sheet display system displays plural graphs in different sizes in chronological order for each total asset, divides each of the plural graphs to show debit on one side and credit on the other side, and further divide thus-obtained debit and credit display areas by debit or credit items, respectively.

### RELATED PRIOR ART DOCUMENT

### Patent Document

Patent Document 1: Japanese Unexamined Patent Application Publication No. 2004-133833

### DISCLOSURE OF THE INVENTION

### Technical Problem

The configuration disclosed in Patent Document 1 may reduce the time required to examine each figure in the financial statements. However, in the first place, in order to understand the operating results and the financial condition of the company by reading these financial statements, certain knowledge of accounting, such as knowledge of a meaning of each figure in the financial statements, is required. A person without sufficient knowledge of accounting may not fully understand the operating results and the financial condition of the company by reading the financial statements.

In view of the above, in order to solve the above-described problem, an object of the present invention to provide an accounting information display method allowing visual understanding of operating results and a financial condition of a company, and a program and an information processing apparatus using the method.

### Means for Solving the Problem

The invention according to claim 1 is
an accounting information display method for displaying information on accounting, the accounting information display method including:
displaying a graph in which one of a vertical axis and a horizontal axis represents profit and the other thereof represents sales;
placing a pictorial figure in the graph, the pictorial figure relating to the sales and being in a size that corresponds to a sales amount of each client; and
placing a pictorial figure in the pictorial figure relating to the sales, the pictorial figure relating to an expense and being in a size that corresponds to an amount of the expense, in which
the pictorial figure relating to the sales is placed at a position corresponding to the profit and the sales in the graph.

The invention according to claim 2 is
an accounting information display method for displaying information on accounting, the accounting information display method including:
displaying a graph in which one of a vertical axis and a horizontal axis represents profit and the other thereof represents sales; placing a pictorial figure in the graph, the pictorial figure relating to the sales and being in a size that corresponds to a sales amount of each product; and
placing a pictorial figure in the pictorial figure relating to the sales, the pictorial figure relating to an expense and being in a size that corresponds to an amount of the expense, in which
the pictorial figure relating to the sales is placed at a position corresponding to the profit and the sales in the graph.

The invention according to claim 3 is
the accounting information display method according to the first or second aspect in which
a pictorial figure that relates to a factor reducing the profit is displayed and connected to the pictorial figure relating to the sales.

The invention according to claim 4 is
a program using an accounting information display method for displaying information on accounting, the program causing an information processing apparatus to:
display a graph in which one of a vertical axis and a horizontal axis represents profit and the other thereof represents sales;
place a pictorial figure in the graph, the pictorial figure relating to the sales and being in a size that corresponds to a sales amount of each client; and
place a pictorial figure in the pictorial figure relating to the sales, the pictorial figure relating to an expense and being in a size that corresponds to an amount of the expense, in which
the pictorial figure relating to the sales is placed at a position corresponding to the profit and the sales in the graph.

The invention according to claim 5 is
a program using an accounting information display method for displaying information on accounting, the program causing an information processing apparatus to:
display a graph in which one of a vertical axis and a horizontal axis represents profit and the other thereof represents sales;
place a pictorial figure in the graph, the pictorial figure relating to the sales and being in a size that corresponds to a sales amount of each product; and
place a pictorial figure in the pictorial figure relating to the sales, the pictorial figure relating to an expense and being in a size that corresponds to an amount of the expense, in which
the pictorial figure relating to the sales is placed at a position corresponding to the profit and the sales in the graph.

The invention according to claim 6 is
an information processing apparatus using an accounting information display method for displaying information on accounting, the information processing apparatus including: control means that
displays a graph in which one of a vertical axis and a horizontal axis represents profit and the other thereof represents sales;
places a pictorial figure in the graph, the pictorial figure relating to the sales and being in a size that corresponds to a sales amount of each client; and
places a pictorial figure in the pictorial figure relating to the sales, the pictorial figure relating to an expense and being in a size that corresponds to an amount of the expense, in which
the pictorial figure relating to the sales is placed at a position corresponding to the profit and the sales in the graph.

The invention according to claim 7 is
an information processing apparatus using an accounting information display method for displaying information on accounting, the information processing apparatus including:
control means that
displays a graph in which one of a vertical axis and a horizontal axis represents profit and the other thereof represents sales;
places a pictorial figure in the graph, the pictorial figure relating to the sales and being in a size that corresponds to a sales amount of each product; and
places a pictorial figure in the pictorial figure relating to the sales, the pictorial figure relating to an expense and being in a size that corresponds to an amount of the expense, in which
the pictorial figure relating to the sales is placed at a position corresponding to the profit and the sales in the graph.

### Advantageous Effects of Invention

In the invention according to claim 1 to claim 7, by displaying the information on accounting, such as the sales, the expense, the profit, and the like of each of the clients or each of the products as described above in the form of the pictorial figure such as a balloon, a user can easily and visually understand such information and easily identify points to be improved. Figures, graphs, and words alone have the limitations. By displaying the information on accounting in the form of the pictorial figure such as the balloon, the information on accounting that appears to be complicated can be converted into information that is easy understood by the user. Just by looking at the pictorial figure such as the balloon, accounting characteristics of the client or the product can be understood at a glance. As a result, it becomes clear how much the profit is increased by how much efficiency is promoted.

It is common practice that, particularly at a small or medium-sized enterprise or an entrepreneurial venture, only the limited number of persons, such as board members, read and acknowledge financial statements including a balance sheet, an income statement, a cash flow statement, and the like. However, by displaying the accounting information in the form of the pictorial figure such as the balloon, everyone in the company (in the enterprise) can acknowledge the accounting information and thus gains a sense of purpose. Furthermore, representation of the pictorial figure such as the balloon becomes a common language within the company.

In addition, the board member or the like who reads the financial statements regularly can only find net sales or net profit from the financial statements. However, by displaying the accounting information in the form of the pictorial figure such as the balloon, it is possible to understand the accounting information by focusing on each customer or product, making it easier and more convenient to formulate measures.

### BRIEF DESCRIPTION OF DRAWINGS

FIG. 1 is a graph illustrating an example of displaying accounting information by using an accounting information display method in a first embodiment of the present invention.

FIG. 2 is a graph illustrating an example of displaying the accounting information by using an accounting information display method in a second embodiment of the present invention.

FIG. 3 is a schematic diagram of an information processing apparatus in a third embodiment of the present invention.

FIG. 4(a) is a table schematically illustrating a configuration of a client information storage area of the information processing apparatus in the third embodiment of the present invention, and FIG. 4(b) is a table schematically illustrating a configuration of a product information storage area of the information processing apparatus in the third embodiment of the present invention.

FIG. 5 is a view illustrating an example of displaying the accounting information by using an accounting information display method in another embodiment of the present invention.

FIG. 6 is a view illustrating an example of displaying the accounting information by using an accounting information display method in further another embodiment of the present invention.

### DESCRIPTION OF EMBODIMENTS

### First Embodiment

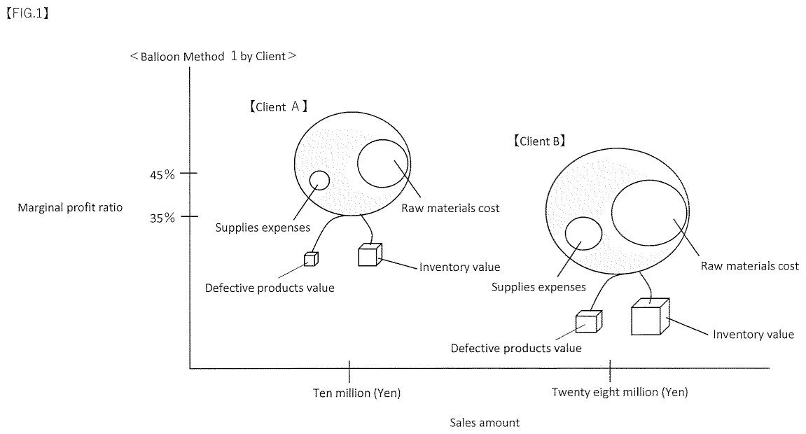

First, a description will be made on an accounting information display method for displaying information on accounting according to a first embodiment with reference to FIG. 1.

As illustrated in FIG. 1, a user prepares a graph in which a vertical axis represents a marginal profit ratio (an example of “profit”) and a horizontal axis represents sales amount (an example of “sales”). The user then places a pictorial figure in the graph. The pictorial figure relates to the sales and is in a size corresponding to the sales amount of each client of the user. This will be described in detail. For example, the pictorial figure relating to the sales is a balloon and is placed in the image of being floated in the graph. Such a balloon is provided per client, and the size thereof (an amount of helium gas to be filled inside the balloon) corresponds to the sales amount. In addition, a position of each of the balloons placed in the graph is determined according to the marginal profit ratio and the sales amount. More specifically, for example, when the sales amount of a client A is ten million yen, and the marginal profit ratio thereof is 45%, a balloon relating to the sales of the client A is placed (plotted) at a position where a line extending perpendicularly (straight up) from a point of ten million yen on the horizontal axis intersects a line extending horizontally (directly sideways) from a point of 45% on the vertical axis. In addition, when the sales amount of a client B is 28 million yen, and the marginal profit ratio thereof is 35%, a balloon relating to the sales of the client B is placed (plotted) at a position where a line extending perpendicularly (straight up) from a point of 28 million yen on the horizontal axis intersects a line extending horizontally (directly sideways) from a point of 35% on the vertical axis.

A pictorial figure that relates to variable cost (an example of an “expense”) and is in a size corresponding to an amount of the variable cost is placed within the balloon relating to the sales of each of the clients. The variable cost is cost that varies by business performance, and examples of the variable cost include purchasing cost, supplies expenses, commission expenses, raw materials cost, outsourcing cost, and transportation cost. For example, in FIG. 1, balloons relating to the supplies expenses and the raw materials cost are placed as the pictorial figures relating to the variable cost in the balloon relating to the client A. A marginal profit is calculated by subtracting the variable costs from the sales amount. Thus, the pictorial figure relating to this variable cost or the variable cost plays a role of reducing the marginal profit ratio (reducing the amount of the helium gas filled in the balloon to lower a height of the balloon).

A pictorial figure that relates to a factor reducing the profit is placed and connected to the balloon relating to each of the clients. This is an image of attaching a weight to the balloon relating to each of the clients. For example, as illustrated in FIG. 1, an inventory value and a defective products value correspond to the pictorial figures, each of which relates to the factor reducing the profit. However, these weights do not lower the marginal profit of the balloon. Display of these factors as the weights plays a role of warning the user that these weights are the factors reducing the profit.

In regard to the inventory (amount), the profit is increased in accounting calculations as the inventory is increased. This leads to erroneous recognition by the user that an increase in the inventory is favorable. However, from a practical managerial standpoint, money is spent wastefully by the increase in the inventory. For this reason, the inventory is displayed as the weight as the factor reducing the profit.

The defective products (amount) are the factor that actually reduces the profit. This is because the raw materials have to be purchased additionally due to the defective products. Here, the raw materials cost for the defective products is already placed (calculated) as the variable cost in the balloon. Thus, the weight relating to the defective products (amount) is merely displayed as an image that represents the factor reducing the profit.

In this way, by displaying the information on accounting, such as the sales amount, the expenses, the profit, and the like of each client or product, in the form of the pictorial figure such as the balloon, the user can easily and visually understand such information and easily identify points to be improved. Figures, graphs, and words alone have limitations. By displaying the information on accounting in the form of the pictorial figure such as the balloon, the information on accounting that appears to be complicated can be converted into information that is easy understood by the user. Just by looking at the pictorial figure such as the balloon, accounting characteristics of the client or the product can be understood at a glance. As a result, it becomes clear how much the profit is increased by how much efficiency is promoted.

It is common practice that, particularly at a small or medium-sized enterprise or an entrepreneurial venture, only the limited number of persons, such as board members, read and acknowledge the financial statements including the balance sheet, the income statement, the cash flow statement, and the like. However, by displaying the accounting information in the form of the pictorial figure such as the balloon, everyone in the company (in the enterprise) can acknowledge the accounting information and thus gains a sense of purpose. Furthermore, the representation of the pictorial figure such as the balloon becomes a common language within the company.

In addition, the board member or the like who reads the financial statements regularly can only find net sales or net profit from the financial statements. However, by displaying the accounting information in the form of the pictorial figure such as the balloon, it is possible to understand the accounting information by focusing on each customer or product, making it easier and more convenient to formulate measures.

In this first embodiment, the description has been made on the configuration that the pictorial figure relating to the factor reducing the profit is displayed as the weight and connected to the balloon relating to each of the clients. However, the present invention is not limited to such a configuration. For example, such a configuration may be adopted that the user does not display the pictorial figure relating to the factor reducing the profit or that the weight is neither displayed nor connected to the balloon relating to each of the clients. By displaying the balloon relating to each of the clients without the weight, it is convenient for the user to evaluate the client itself excluding the inventory, the defective products, and the like.

In addition, in this first embodiment, the description has been made on the configuration that the balloon is used as the example of the pictorial figure that relates to the sales and is in the size corresponding to the sales amount of each of the clients. However, the present invention is not limited thereto. For example, such a configuration may be adopted that a hot air balloon is used as the pictorial figure that relates to the sales and is in the size corresponding to the sales amount of each of the clients.

### Second Embodiment

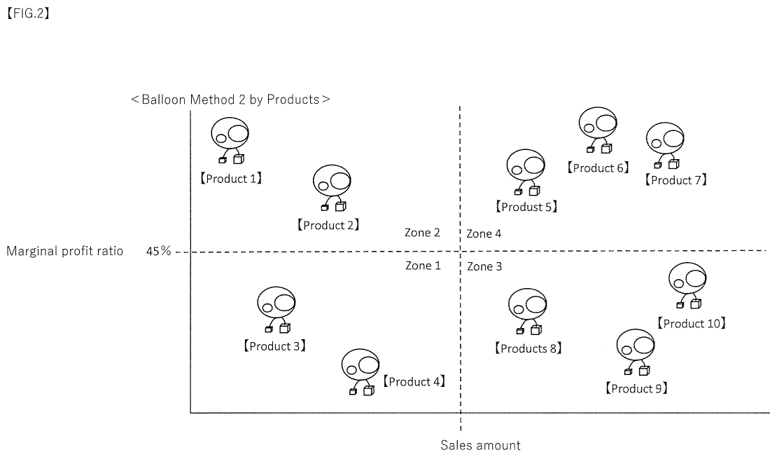

In the above first embodiment, the description has been made on the configuration that the user places the balloon relating to each of the clients as the pictorial figure relating to the sales per client in the graph in which the vertical axis represents the marginal profit ratio and the horizontal axis represents the sales amount. However, the present invention is not limited to such a configuration. In a second embodiment, as illustrated in FIG. 2, the user places the balloons in the graph. The balloon relates to each of the products and is the pictorial figure that relates to the sales per product. In addition, the user divides the graph into four zones of “zone 1: lower left”, “zone 2: upper left”, “zone 3: lower right”, and “zone 4: upper right” by dotted lines. Each of the zones may be displayed in a different color. In this second embodiment, a description will be made on a different configuration from that in the first embodiment. Thus, the configuration that will not be described is the same as that in the first embodiment.

In the “zone 1: lower left”, the sales amount and the marginal profit ratio are low. In the “zone 2: upper left”, the sales amount is low, but the marginal profit ratio is high. In the “zone 3: lower right”, the sales amount is high, but the marginal profit ratio is low. In the “zone 4: upper right, the sales amount and the marginal profit ratio are high. Accordingly, the user can recognize that a product 3 and a product 4, which are placed in the “zone 1: lower left”, have to be moved to the “zone 2: upper left”. In addition, the user can recognize that a product 8, a product 9, and a product 10, which are placed in the “zone 3: lower right”, have to be moved to the “zone 4: upper right”.

By looking at the pictorial figures, each of which is placed in the balloon relating to each product and relates to the variable cost, and the pictorial figures, each of which is connected as the weight to the balloon and relates to the factor reducing the profit, the user can understand a cause why the balloon relating to the product is placed in the zone 1 or zone 3.

In this second embodiment, the description has been made on the configuration that the pictorial figure relating to the factor reducing the profit is displayed as the weight and connected to the balloon relating to each of the products. However, the present invention is not limited to such a configuration. For example, such a configuration may be adopted that the user does not display the pictorial figure relating to the factor reducing the profit or that the weight is neither displayed nor connected to the balloon relating to each of the products. By displaying the balloon relating to each of the products without the weight, it is convenient for the user to evaluate the product itself excluding the inventory, the defective products, and the like.

In addition, in this second embodiment, the description has been made on the configuration that the user divides the graph into the four zones. However, the number of the zones is not limited to four. For example, a configuration that the graph is divided into plural zones, such as six zones or eight zones may be adopted.

Furthermore, in these first and second embodiments, the description has been made on the configuration that the balloon relating to each of the clients or the balloon relating to each of the products is used. However, the objects represented by the balloon are not limited thereto. For example, a configuration of using a balloon relating to each type of business may be adopted. Display of the accounting information, such as the information on the sales amount, the expenses, and the profit of each type of the business, in the form of the pictorial figures such as the balloons enables easily understanding of profitability of each type of the business and thus is convenient.

Moreover, in these first and second embodiments, the description has been made on the configuration that the “marginal profit ratio” is used on the vertical axis of the graph. However, the present invention is not limited to such a configuration. The vertical axis only needs to represent a figure relating to the “profit”. For example, a configuration of using a “marginal profit amount” may be used.

### Third Embodiment

### Configuration of Information Processing Apparatus 1

Next, a description will be made on an information processing apparatus 1 that can display the information on accounting described in the first and second embodiments above and realizes the accounting information display method.

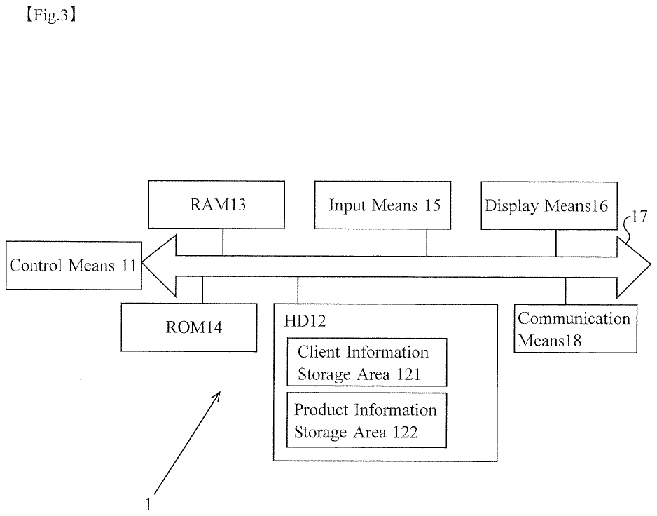

A description will be made on a hardware configuration of the information processing apparatus 1 with reference to FIG. 3. FIG. 3 is a conceptual diagram schematically illustrating hardware of the information processing apparatus 1.

In FIG. 3, control means 11 is realized by a central processing unit (CPU), for example, executes an application program, an operating system (OS), a control program, and the like stored in a hard disk (HD) 12 described below, and executes control for temporarily storing information, files, and the like, which are required for program execution, in random access memory (RAM) 13.

In particular, in response to a command from the user through input means 15, the control means 11 displays the graph, in which the vertical axis represents the marginal profit ratio and the horizontal axis represents the sales amount, on display means 16. In addition, the control means 11 refers to a client information storage area 121 (or a product information storage area 122), and displays the pictorial figure, which relates to the sales of each of the clients (or the pictorial figure relating to the sales of each of the products), such as the balloon in the graph on the basis of the sales amount and the marginal profit ratio of the respective client (or the sales amount and the marginal profit ratio of the respective product). In detail, the control means 11 displays, on the display means 16, the pictorial figure, which relates to the sales of each of the client (or the pictorial figure relating to each of the products), such as the balloon in the size (ratio) corresponding to the sales amount. Furthermore, the control means 11 determines the position of each of the balloons placed in the graph according to the marginal profit ratio and the sales amount. More specifically, for example, when the sales amount of the client A is ten million yen, and the marginal profit ratio thereof is 45%, the balloon relating to the sales of the client A is placed (plotted) at the position where the line extending perpendicularly (straight up) from the point of ten million yen on the horizontal axis intersects the line extending horizontally (directly sideways) from the point of 45% on the vertical axis, as illustrated in FIG. 1.

Moreover, the control means 11 refers to the client information storage area 121 (or the product information storage area 122), and places the pictorial figure, which relates to the variable cost and is in the size corresponding to the amount of the variable cost of each of the clients (or each of the products), in the balloon relating to the sales of the respective client (or the balloon relating to the sales of the respective product). For example, as illustrated in the balloon relating to the client A in FIG. 1, the balloons relating to the supplies expenses and the raw materials cost are placed as the pictorial figures relating to the variable cost. As described above, the control means 11 determines the position of each of the balloons to be placed in the graph according to the marginal profit ratio and the sales amount. Here, since the marginal profit is calculated by subtracting the variable cost from the sales amount, the variable cost affects the position of each of the balloons placed in the graph.

The control means 11 refers to the client information storage area 121 (or the product information storage area 122), and places and connects the pictorial figure, such as the weight, that relates to the factor reducing the profit to the balloon relating to each of the clients (or the balloon relating to each of the products). For example, as illustrated in the balloon relating to the client A in FIG. 1, the inventory value and the defective products value are placed and connected as the pictorial figures that relate to the factors reducing the profit. However, these weights do not lower the marginal profit of the balloon. Display of these factors as the weights plays the role of warning the user that these weights are the factors reducing the profit.

The control means 11 divides the graph, which is displayed on the display means 16, into the plural zones. For example, as illustrated in FIG. 2, the graph is divided into four zones by using the vertical dotted line and the horizontal dotted line.

The RAM 13 is used to temporarily store various types of data, and functions as main memory, a work area, and the like of the control means 11. Read only memory (ROM) 14 stores programs, such as a basic input/output program, and various types of data used in basic processing therein.

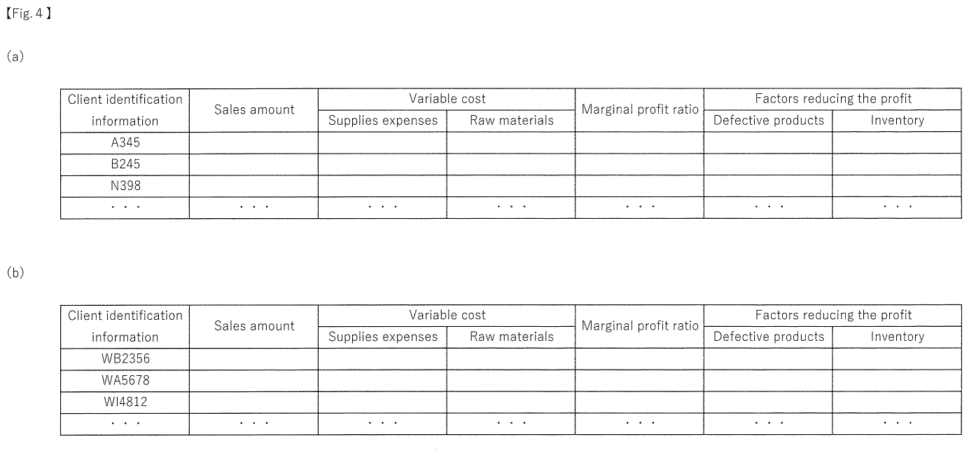

The HD 12 functions as high-capacity memory (storage means), and this HD 12 has the client information storage area 121 and the product information storage area 122. As illustrated in FIG. 4(a), in the client information storage area 121, the client information that has been input by the user through the input means 15 is stored in association with client identification information used to identify each of the clients. For example, the client information includes the sales amount, the variable cost, the factors reducing the profit, and the like relating to the client. As illustrated in FIG. 4(b), in the product information storage area 122, product information that has been input by the user through the input means 15 is stored in association with product identification information used to identify each of the products. For example, the product information includes the sales amount, the variable cost, the factors reducing the profit, and the like relating to the product. In this third embodiment, the description has been made on the configuration using the HD. However, the present invention is not limited thereto. For example, a configuration using a solid state drive (SSD) may be adopted. That is, any configuration suffices as long as the high-capacity memory (storage means) can be used.

The input means 15 accepts input of the information and the command to the information processing apparatus 1 from the user. Examples of the input means 15 are a keyboard, a touch panel, and a button. In particular, the input means 15 accepts, from the user, input of the information on accounting, such as the sales amount, the marginal profit ratio, the variable cost, and the factors reducing the profit of each of the clients as well as the sales amount, the marginal profit ratio, the variable cost, and the factors reducing the profit of each of the products. The input means 15 also accepts, from the user, input of a command to display the accounting information relating to the client (or the accounting information relating to the product).

The display means 16 is a liquid-crystal display, an organic EL display, or a dot-matrix display, for example, and displays the command input from the input means 15, response output of the information processing apparatus 1 to the command, and the like. In particular, the display means 16 displays the graph, in which the vertical axis represents the marginal profit ratio and the horizontal axis represents the sales amount, and the pictorial figure relating to the sales of each of the clients (or the pictorial figure relating to the sales of each of the products), such as the balloon, in the graph.

A bus 17 controls a flow in the information processing apparatus 1. Communication means 18 is an interface (I/F), and the information processing apparatus 1 is connected to an external apparatus via this communication means 18.

In the configuration, software that exerts an equivalent function to each of the devices described above may be used as an alternative to a hardware device.

In the third embodiment, the program and the relevant data according to this third embodiment can be directly loaded into the RAM 13 for execution. In this case, the program and the relevant data may be loaded into the HD 12, in which the program is already installed, each time the program according to this third embodiment is run. It is also possible to store the program according to this third embodiment in the ROM 14, configure the program to form a part of a memory map, and execute the program by the control means 11.

The description has been made on the configuration that, in the information processing apparatus 1 according to this third embodiment, the client information (or the product information) input by the user is stored in the client information storage area 121 (or the product information storage area 122), and the control means 11 retrieves and uses the client information (or the product information) stored in the client information storage area 121 (or the product information storage area 122) when displaying the balloon relating to each of the clients (or the balloon relating to each of the products) in the graph. However, the present invention is not limited to such a configuration. For example, it may be configured that, when accepting the input of the client information (or the product information), the control means 11 uses these pieces of the information to place the balloon relating to the client, and the like in the graph.

### Processing Flow of Information Processing Apparatus 1

Next, a description will be made on a flow processing executed by the information processing apparatus 1. The user uses the input means 15 to input the sales amount, the marginal profit ratio, the variable cost, the factors reducing the profit, and the like of each of the clients. When accepting the input of the sales amount and the like, the information processing apparatus 1 associates the sales amount and the like with the client identification information, and stores the sales amount and the like in the client information storage area 121. The user also uses the input means 15 to input the sales amount, the marginal profit ratio, the variable cost, the factors reducing the profit, and the like of each of the products. When accepting the input of the sales amount and the like, the information processing apparatus 1 associates the sales amount and the like with the product identification information, and stores the sales amount and the like in the product information storage area 122.

Then, when accepting the input of the user's command to display the accounting information relating to the client through the input means 15, the information processing apparatus 1 displays the graph, in which the vertical axis represents the marginal profit ratio and the horizontal axis represents the sales amount, on the display means 16. Then, the information processing apparatus 1 refers to the client information storage area 121 and, as illustrated in FIG. 1, displays the pictorial figure, such as the balloon, relating to the sales of each of the clients in the graph on the basis of the sales amount and the marginal profit ratio of the respective client.

In addition, when accepting the input of the user's command to display the accounting information relating to the product through the input means 15, the information processing apparatus 1 displays the graph, in which the vertical axis represents the marginal profit ratio and the horizontal axis represents the sales amount, on the display means 16. Then, the information processing apparatus 1 refers to the product information storage area 122 and, as illustrated in FIG. 2, displays the pictorial figure, such as the balloon, relating to the sales of each of the products in the graph on the basis of the sales amount and the marginal profit ratio of the respective product.

In these first to third embodiments, the description has been made on the configuration to display the graph in which the vertical axis represents the “profit” and the horizontal axis represents the “sales”. However, the present invention is not limited such a configuration. For example, it may be configured to display a graph in which a vertical axis represents the “sales” and a horizontal axis represents the “profit”.

### First Modified Example

In the examples described in the first to third embodiments, the sales amount of each of the clients or each of the products is represented by the balloon that is filled with the helium gas, and the amount of the helium gas corresponding to the marginal profit is reduced by the amount of the variable cost such that the balloon is floated by the amount corresponding to the marginal profit or the marginal profit ratio (=that the balloon is placed in the graph). However, the configuration that the information on accounting is represented by the balloon filled with the helium gas is not limited to such a configuration.

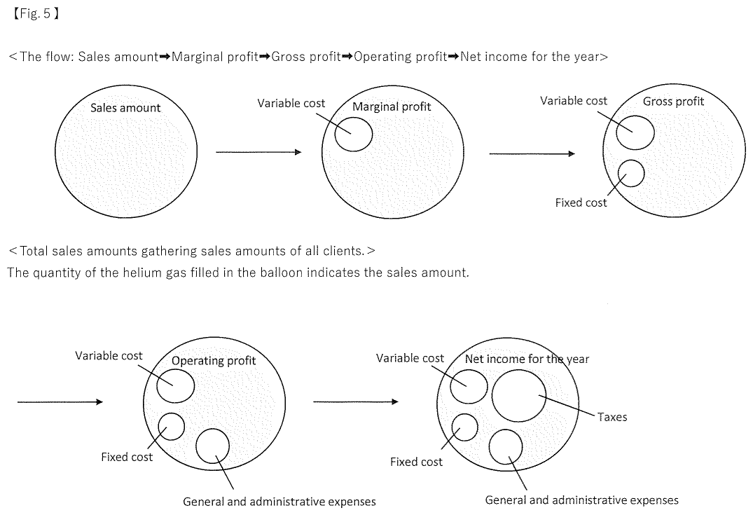

For example, as illustrated in FIG. 5, the user displays the total sales amount of the particular company in the form of the balloon filled with the helium gas. Such a configuration may be adopted that the amount of the helium gas corresponding to the marginal profit is first reduced by the amount of the variable cost to display the “marginal profit”, then reduces the amount of the helium gas corresponding to fixed cost (personnel expenses, rent, lease expenses, and the like) to display the “gross profit”, further reduces the amount of the helium gas corresponding to selling, general and administrative expenses (advertising expenses, entertainment expenses, and the like) to display the “operating profit”, and reduces the amount of the helium gas corresponding to taxes (for example, 40%) to display “net income for the year”.

In this way, by displaying the accounting information, such as the sales amount, the expenses, the profit, and the like of each of the clients or each of the products, in the form of the pictorial figure such as the balloon, visual understanding of such information by the user is facilitated. The figures, the graphs, and the words alone have the limitations. By displaying the information in the pictorial figure such as the balloon, the information on accounting that appears to be complicated can be converted into information that is easy understood by the user.

In these first to third embodiments above, the description has been made on the configuration that the “sales amount”, the “variable cost”, and the “marginal profit ratio” of each of the clients or the like are displayed in the form of the pictorial figures such as the balloons. However, the present invention is not limited to such a configuration. It may be configured to display a combination of the “sales” (=the “sales amount” or the “net sales”), the “expenses” (=subtracted from the “sales”), and the “profit” (=a “profit amount” or a “profit rate”, that is, calculated by subtracting the “expenses” from the “sales”) in the form of the pictorial figure such as the balloon.

More specifically, examples of the combination include a combination of the “sales amount”, the “variable cost”, the “fixed cost”, and the “gross profit” of each of the clients or the like and a combination of the “sales amount”, the “variable cost”, the “fixed cost”, the “selling, general and administrative expenses”, and the “operating profit” of each of the clients or the like.

Then, the “sales” of each of the clients or the like corresponds to the balloon filled with the helium gas. In addition, the “variable cost”, the “fixed cost”, and the “selling, general and administrative expenses” correspond to the “expenses” reducing the helium gas in the balloon. Furthermore, the “marginal profit”, the “gross profit”, and the “operating profit” correspond to the “profit”.

### Second Modified Example

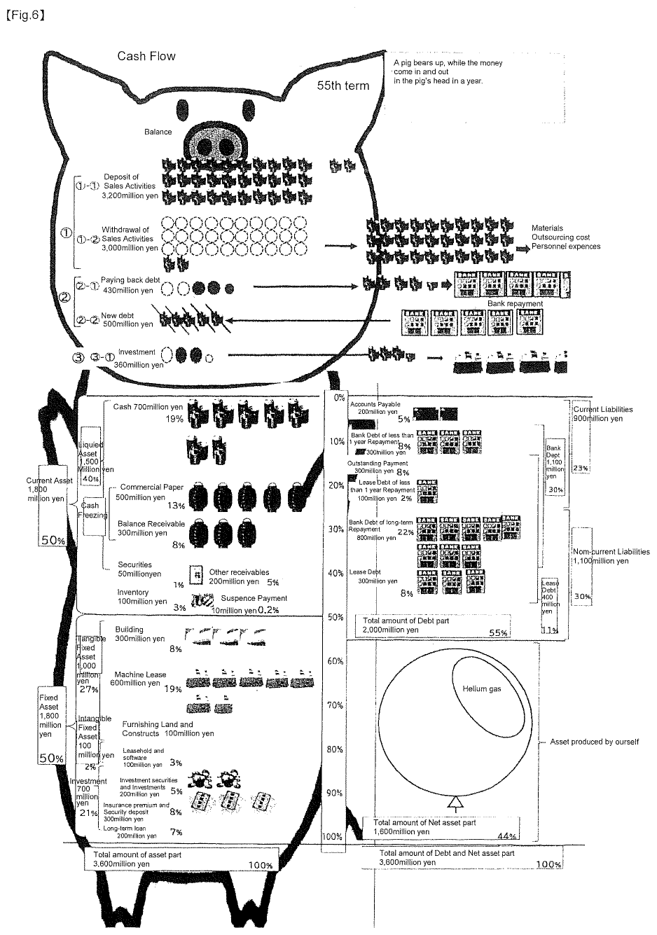

As illustrated in FIG. 6, the user may display a relationship between a cash flow of the company and assets of the company in the form of a piggy bank. The assets (current assets and fixed assets) stored in a body of the piggy bank represent types of property held by the company. On the outside of the piggy bank, the liabilities and net assets are illustrated right beside a body of the piggy bank, and represent sources of the assets. In a head of the piggy bank, movement of money into and out of the company (into the assets and out of the assets) in the current fiscal year (55th year) is displayed. In a section of the net assets illustrated at a lower right corner of FIG. 6, a state where the balloon is added is displayed. The balloon is filled with the total sales amount of the company in the current fiscal year, as the helium gas, which has been described in the first modified example.

By displaying the image of the cash flow in the head and the image of the assets in the body together in the piggy bank, everyone in the company can understand the financial condition of the company. In addition, by further adding and displaying the image of the balloon filled with the helium gas, which represents the total sales amount of the company in the current fiscal year and has been described in the first modified example, the user can further easily understand the financial condition of the company. In this second modified example, the image of the piggy bank is used. However, the present invention is not limited thereto. An image of a money box in the form of another animal may be used, an image of an animal may be simply used, or an image of the money box or an image of a safe may simply be used to display the relationship between the cash flow of the company and the assets of the company.

Also in regard to the configurations in the first and second modified examples, the information processing apparatus 1 may be used to display the information on accounting in the form of the balloon filled with the helium gas or display the relationship between the cash flow of the company and the assets of the company in the form of the piggy bank. In detail, the user uses the input means 15 to input the information on accounting such as the sales amount, and the control means 11 stores these pieces of the input information in the HD 12. Then, in response to the command from the user through the input means 15, the control means 11 uses the information on accounting stored in the HD 12 to display the information on accounting in the form of the balloon filled with the helium gas and display the relationship between the cash flow of the company and the assets of the company in the form of the piggy bank.

The description has been made so far on the preferred embodiments of the present invention. However, the accounting information display method according to the present invention, and the program and the information processing apparatus using the method are not limited to those in the above-described embodiments. It is needless to say that various modifications can be made within the scope of the present invention.

### DESCRIPTION OF REFERENCE NUMERALS AND SYMBOLS

1: information processing apparatus, 11: control means, 12: HD, 121: client information storage area, 122: product information storage area, 13: RAM, 14: ROM, 15: input means, 16: display means, 17: bus, 18: communication means

1. An accounting information display method for displaying information on accounting, the accounting information display method comprising:
displaying a graph in which one of a vertical axis and a horizontal axis represents profit and the other thereof represents sales;
placing a pictorial figure in the graph, the pictorial figure relating to the sales and being in a size that corresponds to a sales amount of each client; and
placing a pictorial figure in the pictorial figure relating to the sales, the pictorial figure relating to an expense and being in a size that corresponds to an amount of the expense, wherein
the pictorial figure relating to the sales is placed at a position corresponding to the profit and the sales in the graph.

2. An accounting information display method for displaying information on accounting, the accounting information display method comprising:
displaying a graph in which one of a vertical axis and a horizontal axis represents profit and the other thereof represents sales;
placing a pictorial figure in the graph, the pictorial figure relating to the sales and being in a size that corresponds to a sales amount of each product; and
placing a pictorial figure in the pictorial figure relating to the sales, the pictorial figure relating to an expense and being in a size that corresponds to an amount of the expense, wherein
the pictorial figure relating to the sales is placed at a position corresponding to the profit and the sales in the graph.

3. The accounting information display method according to claim 1, wherein
a pictorial figure that relates to a factor reducing the profit is displayed and connected to the pictorial figure relating to the sales.

4. A program using an accounting information display method of claim 1 for displaying information on accounting, the program causing an information processing apparatus to:
display a graph in which one of a vertical axis and a horizontal axis represents profit and the other thereof represents sales;
place a pictorial figure in the graph, the pictorial figure relating to the sales and being in a size that corresponds to a sales amount of each client; and
place a pictorial figure in the pictorial figure relating to the sales, the pictorial figure relating to an expense and being in a size that corresponds to an amount of the expense, wherein
the pictorial figure relating to the sales is placed at a position corresponding to the profit and the sales in the graph.

5. A program using an accounting information display method of claim 2 for displaying information on accounting, the program causing an information processing apparatus to:
display a graph in which one of a vertical axis and a horizontal axis represents profit and the other thereof represents sales;
place a pictorial figure in the graph, the pictorial figure relating to the sales and being in a size that corresponds to a sales amount of each product; and
place a pictorial figure in the pictorial figure relating to the sales, the pictorial figure relating to an expense and being in a size that corresponds to an amount of the expense, wherein
the pictorial figure relating to the sales is placed at a position corresponding to the profit and the sales in the graph.

6. An information processing apparatus using an accounting information display method of claim 1 for displaying information on accounting, the information processing apparatus comprising:
control means that
displays a graph in which one of a vertical axis and a horizontal axis represents profit and the other thereof represents sales;
places a pictorial figure in the graph, the pictorial figure relating to the sales and being in a size that corresponds to a sales amount of each client; and
places a pictorial figure in the pictorial figure relating to the sales, the pictorial figure relating to an expense and being in a size that corresponds to an amount of the expense, wherein
the pictorial figure relating to the sales is placed at a position corresponding to the profit and the sales in the graph.

7. An information processing apparatus using an accounting information display method of claim 2 for displaying information on accounting, the information processing apparatus comprising:
control means that
displays a graph in which one of a vertical axis and a horizontal axis represents profit and the other thereof represents sales;
places a pictorial figure in the graph, the pictorial figure relating to the sales and being in a size that corresponds to a sales amount of each product; and
places a pictorial figure in the pictorial figure relating to the sales, the pictorial figure relating to an expense and being in a size that corresponds to an amount of the expense, wherein
the pictorial figure relating to the sales is placed at a position corresponding to the profit and the sales in the graph.

8. The accounting information display method according to claim 2, wherein
a pictorial figure that relates to a factor reducing the profit is displayed and connected to the pictorial figure relating to the sales.

9. The accounting information display method according to claim 1, wherein the method is executed by a CPU of the information processing apparatus.

10. The accounting information display method according to claim 2, wherein the method is executed by a CPU of the information processing apparatus.

11. The program according to claim 4, stored on memory storage of the information processing apparatus to be executed by a CPU of the information processing apparatus.

12. The program according to claim 5, stored on memory storage of the information processing apparatus to be executed by a CPU of the information processing apparatus.

13. The information processing apparatus according to claim 6, comprising a display means and a computer program comprising instructions stored on memory storage of the information processing apparatus which when executed by a CPU of the control means of the information processing apparatus, enable the control means to:
display on display means the graph in which one of the vertical axis and the horizontal axis represents profit and the other thereof represents sales;
place the pictorial figure in the graph, the pictorial figure relating to the sales and being in a size that corresponds to the sales amount of each client; and
place the pictorial figure in the pictorial figure relating to the sales, the pictorial figure relating to the expense and being in the size that corresponds to the amount of the expense,
wherein the pictorial figure relating to the sales is placed at the position corresponding to the profit and the sales in the graph.

14. The information processing apparatus according to claim 7, comprising a display means and a computer program comprising instructions stored on memory storage of the information processing apparatus which when executed by a CPU of the control means of the information processing apparatus, enable the control means to:
display on display means the graph in which one of the vertical axis and the horizontal axis represents profit and the other thereof represents sales;
place the pictorial figure in the graph, the pictorial figure relating to the sales and being in a size that corresponds to a sales amount of each product; and
place the pictorial figure in the pictorial figure relating to the sales, the pictorial figure relating to the expense and being in the size that corresponds to an amount of the expense,
wherein the pictorial figure relating to the sales is placed at the position corresponding to the profit and the sales in the graph.
